(19) United States
(12) Patent Application Publication
(10) Pub. No.: US 2011/0009269 A1
(43) Pub. Date: Jan. 13, 2011

(54) HERBICIDAL COMPOSITION COMPRISING AN AMINOPHOSPHATE OR AMINOPHOSPHONATE SALT AND A VISCOSITY REDUCING AGENT

(75) Inventors: Paul Gioia, Victoria (AU); Poay Huang Chuah, Jurong (SG); Zhi Chao Han, Wuxi City (SG)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Rhodia Operations, Aubervilliers (FR)

(21) Appl. No.: 12/741,799

(22) PCT Filed: Nov. 6, 2008
(86) PCT No.: PCT/EP08/65050

§ 371 Date: Sep. 22, 2010

(30) Foreign Application Priority Data
Nov. 7, 2007 (AU) 2007906130

(51) Int. Cl. A01N 57/20; A01P 13/00

(52) U.S. Cl. 504/206

(57) ABSTRACT

The present invention relates to herbicidal compositions comprising an aminophosphate or aminophosphonate salt, particularly to herbicidal compositions comprising a relatively high amount of aminophosphate or aminophosphonate salt. The compositions comprise an additive compound which is a salt.

### BACKGROUND OF THE INVENTION

The present invention relates to herbicidal compositions comprising an aminophosphate or aminophosphonate salt, particularly to herbicidal compositions comprising a relatively high amount of aminophosphate or aminophosphonate salt and a surfactant-comprising composition of matter.

Among various presentations of compositions comprising glyphosate, concentrated liquid compositions that can be diluted by the end-user (typically a farmer) are of interest. Usually, the higher the glyphosate concentration is, the better it is, because the end-user can set the use concentration (the amount of active applied to the field) by adjusting the dilution rate, and can avoid handling much product (for example the higher the concentration is, the lower the weight is).

Concentrated compositions can comprise a high amount of glyphosate, water, and at least one surfactant compound that can be useful as a formulation aid (dispersion, dissolution and/or stability of the glyphosate in water), and/or as a biological activator (for example increasing the efficacy of glyphosate salt, for example by encouraging wetting of a weed to be eliminated, or by encouraging penetration of the glyphosate into the weed). The amount of glyphosate, the nature of surfactant(s), the amount thereof, and possible further ingredients might have also an effect onto the rheological properties of the composition (for example viscosity, or ability to be spread), as such, or upon dilution. The rheological properties of the composition as such or upon dilution are important for handling and spreading purpose.

Where the concentration of glyphosate is high, crystallization is to be avoided. Crystallization can occur at different temperatures, at different glyphosate concentrations, or when diluting with water. The crystallization is characterized by formation of small solid particles comprising glyphosate. These small particles can have the bad impact of filters clogging, nozzles clogging, creating unnecessary hazardous waste problems to dispose off the crystals, loss of activity (bioefficacy), and/or bad repartition of the active on the field.

Compositions comprising glyphosate and ethoxylated fatty amines surfactants are known. However these compounds are believed to be rather ecotoxic, irritant or slightly biodegradable. There is a need for replacing these compounds or for reducing the amount thereof in the compositions.

Document WO 03/063589 (Rhodia) describes compositions comprising 360 g/L of glyphosate isopropylamine salt (as glyphosate acid equivalent, 783 g/L as salt concentration), a betaine surfactant, and at least one further compound such as optionally ethoxylated amines or etheramines.

Document WO 01/17358 (Albright & Wilson) describes compositions comprising 360 g/L of glyphosate isopropylamine salt (as glyphosate acid equivalent), desalinated alkyl betaines or alkyl amidopropyl betaines surfactants, and optionally ether carboxylates. The document also describes compositions comprising 360 g/L of glyphosate isopropylamine, and alkyl betaines or alkyl amidopropyl betaines surfactants comprising 6 to 12 weight % NaCl. The document teaches that the stability of the composition is linked to presence inorganic salts and teaches that the total level of said inorganic salt is preferably of less than 0.39% by weight. The compositions having desalinated alkyl betaines or alkyl amidopropyl betaines surfactants are taught avoiding crystallization of glyphosate. However desalination is expensive. There is a need in less expensive compositions and/or in compositions comprising higher amounts of glyphosate that do not precipitate and/or in compositions comprising higher amounts of glyphosate that have a reduced viscosity allowing handling them easily.

Document WO 2006/069791 (Rhodia) describes compositions comprising 510 g/L of glyphosate isopropylamine salt (as glyphosate acid equivalent, 783 g/L as salt concentration), a betaine surfactant, and a potassium chloride, that does not form crystals. However these compositions are quite viscous, especially if the amount of glyphosate salt is increased. There is a need for compositions that are less viscous, and/or that comprise higher amounts of glyphosate with a reduced viscosity allowing handling them easily.

### BRIEF SUMMARY OF THE INVENTION

The invention addresses at least one of the concerns above. Thus the invention relates to a herbicidal aqueous composition comprising:

an aminophosphate or aminophosphonate salt, preferably a glyphosate or gluphosinate salt,

a surfactant system, comprising a surfactant product, and

an additive compound, selected from:
salts comprising a cation and an anion, wherein
   the cation is different from Na⁺ and NH₄⁺, and preferably substantially free of Nitrogen,
   the anion comprises at least one oxygen atom and is different from an anion of a dicarboxylic acid, an aminophosphate and an aminophosphonate,
an acid corresponding to the anion, with the provision that the composition also comprises a basic compound that is substantially free of Na⁺ or NH₄⁺.

According to another aspect the invention relates to a process for preparing the herbicidal aqueous composition.

According to another aspect the invention relates to the use of the additive compound in a herbicidal aqueous composition comprising an aminophosphate or aminophosphonate salt and a surfactant system, preferably a glyphosate or gluphosinate salt.

According to another aspect the invention relates to a blend comprising water, a surfactant system and the additive compound, preferably a blend comprising:
water,
from 17% to 28% by weight as active of:
   an alkyl betaine having formula R¹R²R²N⁺—CH₂COO⁻, or
   an alkylamidobetaine having formula R¹—CONR³—R⁴—N⁺(R²)₂—CH₂COO⁻, or
   an alkyl amine oxide having formula R¹—N⁺(R²)₂—O⁻, or
   an alkylamidoamine oxide having formula R¹—CONR³—R⁴—N⁺(R²)₂—O⁻
wherein:
   R¹ is a linear or branched hydrocarbon group, preferably an alkyl group containing 3 to 30 carbon atoms, preferably 3 to 20 carbon atoms,
   R², identical or different, is a C₁-C₃ alkyl group, preferably a methyl group,
   R³ is a hydrogen atom or a C₁-C₃ alkyl group, and
   R⁴ is a divalent C₁-C₆ alkyl group, preferably a —(CH₂)₃— group
      and
from 5% to 25% as active of an additive compound, selected from:
   salts comprising a cation and an anion, wherein
      the cation is different from Na⁺ and NH₄⁺, and preferably substantially free of Nitrogen,
      the anion comprises at least one oxygen atom and is different from an anion of a dicarboxylic acid, an aminophosphate and an aminophosphonate,
   an acid corresponding to the anion, with the provision that the composition also comprises a basic compound that is substantially free of Na⁺ or NH₄⁺.

The invention also relates to the use of the composition.

The composition according to the invention, presents a suitable practical low (reduced thanks to presence of the additive compound) viscosity, even at higher concentrations of aminophosphate or aminophosphonate salt, for example at concentrations of about as high as 360 g/L, or even 480 g/L, or even 510 g/L, or even 540 g/L. The compositions according to the invention also have a very good surprisingly compatibility with other plant protection (for example herbicides) compositions, especially upon tank mixing. The invention provides, inter alia, compositions with an improved compatibility, compared to other commercial aqueous aminophosphate or aminophosphonate salt compositions having an equal amount of aminophosphate or aminophosphonate salt, for example 540 g/L.

### DETAILED DESCRIPTION OF THE INVENTION

### Definitions

In the present specification, unless otherwise provided, the amounts of aminophosphate or aminophosphonate salt, preferably a glyphosate or gluphosinate salt salts are expressed as acid equivalents.

In the present specification, a “surfactant system” refers to at least ingredient comprising at least one surfactant molecule, used to prepare the composition, as well as an association or mixture of ingredients comprising at least one surfactant product which are provided separately in the composition or as a mixture prepared before introduction.

In the present specification, a “surfactant product” refers to an ingredient comprising a surfactant molecule, preferably a single surfactant molecule or a single genius of surfactant molecule. A surfactant product can be in the form of a substantially pure surfactant molecule or genius or surfactant molecule, or in a form of a composition of matter comprising the surfactant molecule and other products, for example water and/or other products such as salts, by products etc. . . . .

In the present specification, a “surfactant composition of matter” refers to a composition of matter comprising a surfactant molecule and other products, said other product including typically water and/or products such as salts, by-products etc. . . . . A surfactant composition of matter can be a reaction adduct. Surfactants are usually reaction adducts comprising several different compounds. These different compounds have effects on the herbicidal composition. Hence it is referred to surfactant compositions of matter. Thus in the present specification a surfactant composition of matter is understood as a mixture comprising water, a chlorine based salt, the surfactant active molecule(s), and optionally further compounds such as pH buffers.

In the present specification, unless otherwise provided, the amounts of surfactant system or of surfactant composition of matter, are the total amounts of a mixture or association (amounts “as is”), as opposed to amounts as active matter, dry matter amounts (solid content), or the like.

In the present specification, unless otherwise provided, the amounts of surfactant active matter, for a surfactant composition of matter or system, for example the betaine surfactant composition of matter or the surfactant system, are defined as the dry matter amount of the surfactant ingredient or system, minus the total amount of salt in the surfactant ingredient or system.

In the present specification, “chloride based salts” refer to any salt having Cl⁻, particularly KCl or NaCl. The amounts thereof can be determined by conventional means. The amounts, unless otherwise provided relate to amounts by weight in the herbicidal composition.

In the present specification, “substantially no compound” refers to amounts of said compound of lower than 1% by weight, preferably lower than 0.1%, preferably lower than 0.01%.

The ingredients of the composition are described below. Any combination thereof and therein can be implemented to defined, and/or prepare the composition according to the invention, and/or the uses according to the invention.

### Aminophosphate or Aminophosphonate Salt

Aminophosphate or aminophosphonate salts are known by the one skilled in the art. Preferred salts are glyphosate or gluphosinate salts.
Glyphosate refers to N-(phosphonomethyl)glycine.
Gluphosinate refers to 4-[hydroxy(methyl)phosphinoyl]-DL-homoalanine.
The salts include:

sodium (Na) salts;

potassium (K) salts;

ammonium salts having N(R)₄⁺ cations wherein R groups, identical or different, represent a hydrogen atom or a linear or non linear, saturated or unsaturated C₁-C₆ hydrocarbon group optionally substituted by a hydroxyl group, for example isopropylamine salts;

sulphonium salts; said salts being present alone or in a combination.

Ammonium salts that can in particular be cited include salts obtained from secondary or primary amines such as isopropylamine (IPA), dimethylamine, diamines such as ethylenediamine, or alkanolamines such as monoethanolamine (MEA). Trimethylsulphonium is a perfectly suitable sulphonium salt.

Preferred glyphosate salts for herbicidal application that can be cited are isopropylamine (IPA—or “isopropylammonium”) salt, monoethanolamine (MEA) salt, trimethylsulphonium salt, potassium salt, ammonium salt, and mixtures or associations thereof, for example as taught in documents WO01/26469 (Nufarm) and WO03/013241 (Nufarm). Advantageously the aminophosphate or aminophosphonate salt comprises at least 10% by weight, preferably at least 50%, preferably at least 90%, of isopropylammonium aminophosphate or aminophosphonate salt, such as isopropylammonium glyphosate, or of potassium aminophosphate or aminophosphonate salt, such as potassium glyphosate salt.

In the present invention isopropylamine containing salts are preferred. Thus in a preferred embodiment the salt is a glyphosate isopropylamine salt. In a preferred embodiment, the ratio between the cation such as the cation of isopropylamine and glyphosate is of about 1/1. However the ratio can of higher than 1/1. Such a ratio provides compositions having higher pH. The higher the pH, the lower the crystallization. pH can be also managed by using any other basic compound, for example KOH or other buffers.

The composition comprises advantageously at least 360 g/L of aminophosphate or aminophosphonate salt, as acid equivalent, preferably at least 450 g/L, preferably at least 510 g/L, preferably at least 525 g/L, for example equal to 540 g/L±5%. The composition can typically comprise up to 560 g/L of aminophosphate or aminophosphonate salt.

The composition comprises advantageously at least 360 g/L of glyphosate isopropylamine salt, preferably at least 450 g/L, preferably at least 510 g/L, preferably at least 525 g/L, for example equal to 540 g/L±5%. The composition can typically comprise up to 560 g/L of glyphosate isopropylamine salt.

The composition comprises advantageously at least 360 g/L of potassium glyphosate salt, preferably at least 450 g/L, preferably at least 510 g/L, preferably at least 525 g/L, for example equal to 540 g/L±5%. The composition can typically comprise up to 560 g/L of potassium glyphosate salt.

The salt will generally be formed upon preparation of the composition by adding whole or a part of the total aminophosphate or aminophosphonate in acid form, and neutralizing to form the salt with the corresponding amount of base (such as KOH, amine etc). If only a part has been introduced and prepared, then the remaining can be added wholly or as parts.

### Additive Compound

The additive compound is a salt comprising a cation and an anion, wherein

cation is different from Na⁺ and NH₄⁺, and preferably substantially free of Nitrogen,

the anion comprises at least one oxygen atom and is different from an anion of a dicarboxylic acid, an aminophosphate and an aminophosphonate.

In one embodiment the additive compound is an acid corresponding to the anions, with the provision that the composition also comprises a basic compound that is substantially free of Na⁺ or NH₄⁺. In other words the salt can be prepared in situ in the composition, by introduction of the acid on one hand and of the base on another hand. If such an embodiment is carried out, then it is preferred that the acid and/or base are introduced before the introduction of the aminophosphate or aminophosphonate as an acid to be subsequently neutralized to form the salt thereof.

According to a specific embodiment the cation of the additive compound is K⁺.
According to a specific embodiment the anion is:

an anion of a mono-carboxylic acid, preferably an anion of an alkyl or hydroxyalkyl mono-carboxylate

a sulfate or sulfonate,

a phosphate or phosphonate,

a nitrate.

According to a specific embodiment the salt is selected from Potassium Lactate, KNO₃, KH₂PO₄, K₂HPO₄, Potassium gluconate, potassium sulfate, potassium sulfate and KIO₃. Potassium Lactate is especially practical as it is a liquid with a good physical compatibility with surfactants. If it is used in a blend with a surfactant, it can improve the physical stability surfactants products, for example by preventing gels formations.

The additive compound can be provided in the composition as a pure solid or liquid compound, or as a solution for example in water.

The amount of the additive compound in the composition can be for example of:

from 5 g/L to 100 g/L (as active), preferably 10 g/L to 70 g/L, and/or

from 0.5 wt % to 10 wt % (as active), preferably from 1 wt % to 7 wt %.

### Surfactant System

The surfactant system comprises at least one surfactant product. It can comprise several surfactant products.

If the surfactant system comprises several surfactant products the different surfactant(s) can be provided in the herbicidal composition as separate ingredients; it can be thus referred to an association. In another embodiment, at least one of the different surfactant(s) can be provided as a mixture with the betaine surfactant composition of matter, it can be thus referred to a mixture or a blend. In that embodiment the different surfactant can be prepared separately and simply mixed or prepared in the same course of process of the preparation of the different surfactant molecules.

Some surfactant products that are suitable for being used in aqueous compositions comprising aminophosphate or amoniphosphonate salts, especially glyphosate salts are known by the one skilled in the art and have been described in the prior art. These are sometime also referred to as “bioactivators”. Suppliers of such products generally indicate that the surfactant product is suitable for formulating various aminophosphate or amoniphosphonate salts.

Some useful surfactant products comprise a surfactant molecule having a cationic charge. Some especially efficient, practical, and/or eco-friendly surfactant products comprise a surfactant molecule having both a cationic charge and an anionic charge (amphoteric or zwitterionic surfactants).

Examples of particularly suitable surfactants product are surfactant products comprising a betaine group or an amine oxide group. Other surfactants that can be used, alone or combined with other, such as surfactant products comprising a betaine group or an amine oxide group, are mentioned below under the section “other surfactants”.

The composition of the invention preferably comprises at least 80 g/L, preferably at least 100 g/L, preferably at least 120 g/L, for example from 150 g/L to 180 g/L, of the surfactant system. Preferably the surfactant active matter is of at least 20% by weight, preferably at least 25%, preferably at least 32%; of the surfactant system.

The surfactant product can for example comprise:
an alkyl betaine having formula R¹R²R²N⁺—CH₂COO⁻, or
an alkylamidobetaine having formula R¹—CONR³—R⁴—N⁺(R²)₂—CH₂COO⁻, or
an alkyl amine oxide having formula R¹—N⁺(R²)₂—O⁻, or
an alkylamidoamine oxide having formula R¹—CONR³—R⁴—N⁺(R²)₂—O⁻
   wherein:

R¹ is a linear or branched hydrocarbon group, preferably an alkyl group containing 3 to 30 carbon atoms, preferably 3 to 20 carbon atoms,

R², identical or different, is a C₁-C₃ alkyl group, preferably a methyl group,

R³ is a hydrogen atom or a C₁-C₃ alkyl group, and

R⁴ is a divalent C₁-C₆ alkyl group, preferably a —(CH₂)₃— group.

The products comprising a betaine group, especially the alkyl betaines, are for example especially suitable for compositions having an isopropylammonium salt of aminophosphate or amoniphosphonate, particularly isopropylammonium salt of glyphosate. They provide for example a good bioactivity, a good formulation (stability, lack of crystallization, viscosity), and a good environmental profile.

The products comprising a amine oxide group, especially the alkyl amine oxide, are for example especially suitable for compositions having an isopropylammonium salt of aminophosphate or amoniphosphonate, particularly isopropylammonium salt of glyphosate. They provide for example a good bioactivity, a good formulation (stability, lack of crystallization, viscosity), and a good environmental profile.

The surfactant system comprises, as surfactant products, surfactant composition of matter. The surfactant system can comprise the surfactant composition of matter A) “betaine surfactant composition of matter” and/or the surfactant composition of matter B) “amine oxide surfactant composition of matter”, being both detailed below. The surfactant system optionally comprises at least one surfactant different from the betaine of the betaine surfactant composition of matter and from the amine oxide of the amine oxide surfactant composition of matter.

### Betaine Surfactant Composition of Matter A)

A) is a betaine surfactant composition of matter comprising:

A1) water,

A2) a betaine having formula R¹R²R²N⁺—CH₂COO⁻, wherein:
R¹ is a linear or branched hydrocarbon group, preferably an alkyl group containing 3 to 30 carbon atoms, preferably 3 to 20 carbon atoms,
R², identical or different, is a C₁-C₃ alkyl group, preferably a methyl group, and

A3) at least 1% by weight of a chloride based salt, preferably of a potassium chloride salt.

The betaine is a main surfactant compound of the betaine surfactant composition of matter. It is preferably the main surfactant compound of the surfactant system. It is also referred to the main surfactant. By main surfactant compound it is meant that said surfactant compound represents the highest surfactant active matter compared to optional other surfactant(s). For example, in a mixture or association comprising 40 parts as active of surfactant 1, 30 parts as active of surfactant 2, and 30 parts as active of surfactant 3, surfactant 1 would be considered as main surfactant even if it represents lower than 50% of all surfactants.
Preferably the betaine active matter represents at least 30% by weight, preferably at least 50%, of the total surfactant active matter of the surfactant system in the composition.
Advantageously the betaine surfactant composition of matter comprises:

water,

at least 20%, preferably at least 25%, preferably at least 32%, by weight as active surfactant matter of the betaine,

at least 2%, preferably at least 5%, by weight of a potassium chloride salt.

Preferably the betaine surfactant composition of matter comprises:

water,
at least 20%, preferably at least 25%, preferably at least 32% by weight as active surfactant matter of the betaine,

at least 5% by weight of a potassium chloride salt, and

substantially no sodium cation.

In a preferred embodiment, the total amount of inorganic salts in the surfactant system, preferably of chloride-based salts, is of higher than 0.4% by weight, and preferably higher than 1% by weight.

In a preferred embodiment, the amount of inorganic salts, preferably of chloride-based salts, is of higher than 8%, preferably higher than 10%, preferably higher than 12%, by weight of the amount of the betaine surfactant composition of matter.

In a preferred embodiment, the total amount of inorganic salts, preferably of chloride-based salts, is of higher than 8%, preferably higher than 10%, preferably higher than 12%, by weight of the amount of the surfactant system.

The betaine has preferably R² being a methyl group (alkyldimethylbetaines).

R¹ is an alkyl group. This group is usually actually a mixture of different groups having different numbers of carbon atoms, being linear or branched, and optionally having some insaturations. These mixtures come from the reagents used to prepare them, which are actually distillation cuts and/or have a natural origin. In the present specification the number of carbon atoms in the R¹ group refers to the number of carbon atoms of the two most represented species.

In a preferred embodiment:

R² is a methyl group, and

R¹ is a lauryl alkyl group mixture, having more than 50% by weight of C₁₂.

The betaine surfactant composition of matter can be obtained by, and is preferably obtained from, a process comprising the following steps:
step 1) reacting a compound of formula R¹R²R²N with chloroacetic acid, to obtain a reaction product;
step 2) adding potassium hydroxide to increase the pH,
step 3) optionally adding some further ingredients or adjusting the concentration or pH.

It is mentioned that step 1 and step 2 can also be performed simultaneously, by adding potassium hydroxide during reaction completion or by adding progressively chloroacetic acid and potassium hydroxide.

In another embodiment potassium chloroacetate is used in step 1) instead of chloroacetic acid, and step 2) is optional.

In a preferred embodiment, the process does not comprise any desalination step or ion exchange step. Thus the process is cost effective, and therefore the herbicidal composition can also be cost interesting.

Advantageously, the pH of the betaine surfactant composition of matter is of from 6 to 8, in a 1% by weight water solution.

### Amine Oxide Surfactant Composition of Matter B)

B) is an amine oxide surfactant composition of matter comprising:

B1) optionally water,

B2) an amine oxide having formula R¹—N⁺(R²)₂—C⁻, wherein:
R¹ is a linear or branched hydrocarbon group, preferably an alkyl group containing 3 to 30 carbon atoms, preferably 3 to 20 carbon atoms,
R², identical or different, is a C₁-C₃ alkyl group, preferably a methyl group, and

B3) optionally a solvent different from water.

Such surfactant compositions of matter are known, and are available on the market.

The R group is usually actually a mixture of different groups having different numbers of carbon atoms, being linear or branched, and optionally having some insaturations. These mixtures come from the reagents used to prepare them, which are actually distillation cuts and/or have a natural origin. In the present specification the number of carbon atoms in the R group refers to the number of carbon atoms of the two most represented species.

Preferably R has an average number of carbon atoms of from 10 to 18. Advantageously R is an alkyl group comprising at least 50% by weight of a lauryl or myristyl group, preferably a lauryl group.

The solvent is preferably a polar solvent.
The solvent is preferably water-miscible.
Useful solvent in herbicides formulations are known by the one skilled in the art.
For examples, the solvent can be:

a water-miscible glycol ether,

a water-miscible alcohol,

a water-miscible ketone

a water-miscible aldehyde

a water-miscible acetate.

Useful solvents include:
N-methyl-pyrrolidone (NMP, can be further identified for example with CAS number 872-50-4)
diester solvents,
propylene carbonate,
acetophenone,
ethylene glycol butyl ether,
diethylene glycol butyl ether,
methoxy methyl butanol,
propylene glycol methyl ether,
dipropylene glycol methyl ether,
gamma-butyrolactone,
dimethyl formamide (DMF),
furfuryl alcohol,
tetrahydrofuryl alcohol,
neopentyl glycol,
hexadiols,
hexylene glycol,
glycol ether amines,
ethylene glycol monoacetate, or
a mixture or association thereof.

Advantageously the total surfactant active matter of the surfactant system in the composition is comprised of at least 20% by weight, preferably at least 30%, preferably at least 50% of betaine active matter, preferably of alkylbetaine active matter, or amine oxide active matter, preferably of alkyl amine oxide active matter.

Advantageously the composition of the invention comprises at least 80 g/L, preferably at least 100 g/L, preferably at least 120 g/L, for example from 150 g/L to 180 g/L, of a betaine and/or amine oxide surfactant composition of matter. Preferably the alkylbetaine or alkylamine oxide surfactant active matter is of at least 20% by weight, preferably at least 25%, preferably at least 32%; of the surfactant system.

### Other Surfactants

The herbicidal composition can comprise surfactant products different from surfactant products comprising a betaine or an amine oxide group. This further surfactant can provide further advantages or synergies in term of costs, and/or bioefficacy, and/or rheology management, and/or environment concerns and/or sensitivity concerns.

Examples of further surfactants include:

an ethoxylated fatty amine, a fatty amine,

an ether carboxylate,

an acid or non acid mono- and di-ester phosphate, optionally polyalkoxylated,

an alkylmonoglycoside or alkylpolyglycoside, advantageously octylglycoside, an octylpolyclycoside, decylglycoside, a decylpolyglycoside, or a mixture thereof, or

mixtures thereof.

The fatty amines or ethoxylated fatty amines can comprise at least one hydrocarbon group containing 2 to 24 carbon atoms, optionally polyalkoxylated.

The fatty amines or ethoxylated fatty amines can more particularly be selected from amines comprising at least one linear or branched, saturated or unsaturated group containing 2 to 24 carbon atoms, preferably 8 to 18 carbon atoms, optionally comprising 2 to 30 oxyethylene groups, or a mixture of a plurality thereof. Examples include ethoxylated tallow amines.

The fatty amines or ethoxylated fatty amines can be selected from ethoxylated fatty amines comprising at least one linear or branched, saturated or unsaturated groups containing 6 to 24 carbon atoms, preferably 8 to 20 carbon atoms, comprising 2 to 30 oxyethylene groups, or a mixture of a plurality thereof. Examples include the compounds having the following formula:

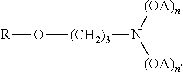

wherein R represents a linear or branched, saturated or unsaturated hydrocarbon group containing 6 to 24 carbon atoms, preferably 8 to 20 carbon atoms; OA represents an oxypropylene group; and n, n′, which may or may not be identical, represent a mean number in the range 1 to 30.

Examples of such amines that can be cited are amines derived from copra and containing 5 oxyethylene (OE) motifs, oleic amines containing 5 OE, amines derived from tallow containing 5-20 OE, for example 10, compounds corresponding to the above formula, in which R is an alkyl group containing 12 to 15 carbon atoms, the number of OE motifs being in the range 20 to 30.

The amount of fatty amines or ethoxylated fatty amines can be of from 0 (none) to 120 g/l of the composition, preferably of from 0 (none) to 60 g/l.

The ether carboxylate has preferably formula R(OCH₂CH₂)ₙOCH₂CO₂, wherein R is a linear or branched alkyl, alkenyl, alkylphenyl or polypropyleneoxy group having from 6 to 20, for example 8 to 14, aliphatic carbon atoms and n is of from 1 to 30, preferably of from 2 to 20. The ether carboxylate has preferably a counter ion being ammonium or potassium, or obtained from an amine or alkanolamine having up to 6 carbon atoms.

The acid or non acid mono- and di-ester phosphate, optionally polyalkoxylated is selected from acid or non acid phosphate mono- or di-esters, optionally polyalkoxylated, with the formula below:

(AO)₃₋ₘP(═O)(OM)ₘ

wherein:
A, identical or different, represents a group R′¹—O(CH₂—CHR′²—O)ₙ wherein:
   R′¹, identical or different, represents a linear or non linear, saturated or unsaturated C₆-C₂₀ hydrocarbon group, preferably C₈-C₁₈;
   R′², identical or different, represents a hydrogen atom or a methyl or ethyl group, preferably a hydrogen atom;
   n is a mean number of motifs in the range 0 to 10, preferably in the range 2 to 10;
M, identical or different, represents a hydrogen atom, an alkali or alkaline-earth metal, a N(R³)₄⁺ type radical wherein R³, identical or different, represents a hydrogen atom or a linear or non linear, saturated or unsaturated C₁-C₆ hydrocarbon group optionally substituted with a hydroxyl group;
m is a whole or average number in the range 1 to 2.

The acid or non acid mono- and di-ester phosphate, optionally polyalkoxylated can be in the form of a monoester, a diester, or a mixture of these two esters.

The amount of acid or non acid mono- and di-ester phosphate, optionally polyalkoxylated can be of from 0 (none) to 120 g/l of the composition.

### Further Ingredients

The herbicidal composition can comprise further ingredients, such as:

surfactants different from the betaine of the betaine surfactant composition of matter, as part of the surfactant system,

anti-foaming agents,

solvents, preferably water miscible solvent, preferably polar solvents,

humectants, or

deposition control agents such as anti-rebound or anti-drift agents, optionally added afterward.

The one skilled in the art knows further ingredients that can be used for managing some properties or features of the composition and/or for adding benefits.

The formulations can for example comprise for example:

organopolysiloxanes antifoaming agent;

thickening agents such as xanthan gum type polysaccharides, alginates, carboxylated or hydroxylated methylcelluloses, synthetic macromolecules of the polyacrylate, polymaleate, polyvinylpyrrolidone, polyethylene glycol or polyvinyl alcohol type, or of the inorganic type such as bentonites.

auxiliary additives such as antioxidants, anti-UV agents, colorants, etc.

solvent such as an alcohol, for example isopropanol, typically up to 15% by weight,

humectants for example glycerin.

The amount of these additives listed above can be of less than 10% by weight, preferably 1% by weight or less, advantageously 0.1% by weight or less compared with the composition weight. Glycerin can introduced blended in a surfactant product, the amount thereof in the surfactant product can be for example of from 10% to 65% by weight, relative to the surfactant product.

### Herbicidal Composition Preferred Features

The composition of the invention can for example comprise:

from 360 g/L to 560 g/L of the aminophosphate or aminophosphonate salt, preferably of glyphosate salt,

from 80 g/L to 180 g/L of the surfactant system, preferably of the betaine surfactant composition of matter, and

from 5 to 100 g/L, preferably from 10 to 70 g/L of the additive compound.

According to one embodiment the composition comprises:

from 400 to 500 g/L of glyphosate isopropylamine salt,

from 80 to 140 g/L of the surfactant system, preferably of the betaine surfactant composition of matter, and

from 10 to 70 g/L of the additive compound.

According to one embodiment the composition comprises:

from 500 to 525 g/L of glyphosate isopropylamine salt,

from 100 to 150 g/L, of the surfactant system, preferably of the betaine surfactant composition of matter, and

from 10 to 70 g/L of the additive compound.

According to one embodiment the composition comprises:

from 525 to 560 g/L of glyphosate isopropylamine salt,

from 120 to 180 g/L, of the surfactant system, preferably of the betaine surfactant composition of matter, and

from 10 to 70 g/L of the additive compound.

According to one embodiment the composition comprises:

from 400 to 500 g/L of potassium glyphosate salt,

from 80 to 140 g/L of the surfactant system, preferably of the amine oxide surfactant composition of matter, and

from 10 to 70 g/L of the additive compound.

According to one embodiment the composition comprises:

from 500 to 525 g/L of potassium glyphosate salt,

from 100 to 150 g/L, of the surfactant system, preferably of the amine oxide surfactant composition of matter, and

from 10 to 70 g/L of the additive compound.

According to one embodiment the composition comprises:

from 525 to 560 g/L of potassium glyphosate salt,

from 120 to 180 g/L, of the surfactant system, preferably of the amine oxide surfactant composition of matter, and

from 10 to 70 g/L of the additive compound.

### Process for Preparing the Herbicidal Composition

The compositions of the invention can be prepared by mixing their different constituents with moderate stirring.

This operation preferably takes place at a temperature in the range 15° C. to 60° C., preferably at a temperature close to ambient temperature (15-30° C.).

According to a practical embodiment, the process for preparing the composition comprises the steps of:

step a) preparing a blend comprising a surfactant product and the additive compound,

step b) mixing the blend with the further components of the composition.

Step a) can comprise preparing a betaine surfactant composition of matter by a process comprising the following steps:
step 1) reacting a compound of formula R¹R²R²N with chloroacetic acid, to obtain a reaction product,
step 2) adding potassium hydroxide to increase the pH,
step 3) adding additive compound,
step 4) optionally, before or after step 3), adjusting the concentration or pH.

It is mentioned that step 1 and step 2 can also be performed simultaneously, by adding potassium hydroxide during reaction completion or by adding progressively chloroacetic acid and potassium hydroxide.

In another embodiment potassium chloroacetate is used in step 1) instead of chloroacetic acid, and step 2) is optional.

The blend allows reducing the number of steps and of raw materials to be used for obtaining the composition of the invention. It also allows handling liquids. The blend can itself be considered as a surfactant product. It has been found that the presence of the additive compound in the blend improves physical stability and eases handling of the surfactant products, especially of betaine composition of matters and of amine oxide surfactant products and/or compositions of matter. It allows form example having higher active surfactants molecules in the product while avoiding formation of gels that a difficult to handle. Thus the presence of the additive compound widens compositions windows (higher concentration allow less water, and thus make it possible to manage in wider ranges the amount of water to be used and/or processed for preparing the final composition).

Step b) can comprise the steps of providing a mixture of water and the aminophosphate or aminophosphonate salt such as glyphosate salt, said mixture representing whole or a part of the aminophosphate or aminophosphonate salt such as glyphosate salt in the composition, then adding whole or a part of the blend, and then optionally mixing remaining parts of the glyphosate salt and/or to the blend.
According to another embodiment, the process for preparing the composition can comprise the steps of:

step a′) providing a mixture of water and the aminophosphate or aminophosphonate salt such as glyphosate salt, said mixture representing whole or a part of the aminophosphate or aminophosphonate salt such as glyphosate salt in the composition, then adding whole or a part of surfactant system, then

step b′) adding whole or a part of the additive compound, and

optionally step c′) mixing remaining parts of the aminophosphate or aminophosphonate salt such as glyphosate salt and/or to surfactant system, before or after step b′)

optionally step d′) mixing a remaining part or the additive compound, after step b′), during or after step c′) if step c′) is performed after step b′).

The composition, when finished, might by filled in containers. According to one embodiment, the final concentration of the composition is monitored directly in the containers by adding some water in said container, up to the desired volume to achieve a desired aminophosphate or aminophosphonate salt concentration. The containers can for example have a volume allowing from 0.1 L to 10000 L to be filled in, for example 1 L or 10 L or 25 L or 100 L or 1000 L or 5000 L. The containers are then typically charged onto a transportation vehicle, such as a donkey, a truck, a car, a boat, an airplane, a train, and/or a succession thereof, with optional storage, and delivered to a farm. The farmer will then typically dilute it with water in a tank and apply it after dilution.

### Downstream Use

The herbicidal composition of the invention can be thus used to treat plants, normally after diluting with water. The diluted composition can be applied onto a field by any appropriate mean.

The dilution, and the application onto the field, can be for example such that the amount of aminophosphate or aminophosphonate salt, preferably glyphosate salt, is of from 500 g acid equivalent/ha to 1500 g acid equivalent/ha, typically from 600 to 1200 g/ha. The invention provides a good bioefficacy.

Upon dilution the end-user can admix other herbicides, pesticides, fertilizers, fungicides. For example the end-user can combine the glyphosate salt with other herbicides to address some weed-resistances to glyphosate. The composition according to the invention, for example with glyphosate isopropylamine salt, provides a good compatibility with other herbicides. The invention can allow high loads of glyphosate salts with good compatibility.

The presence of the additive agent allows having composition with a reduced viscosity, that are easy to pour and/or to pump with commonly used pumps, which is especially interesting when the container is a 100 L or higher container, for example a 1000 L container. It allows the farmer to use its common equipment.

Some details or advantages of the invention will appear in the non-imitative examples below.

### EXAMPLES

The following ingredients are used:

Surfactant system 1: surfactant composition of matter comprising the following:
About 29 wt % Active betaine: Alkyldimethylbetaine, wherein the alkyl is a mixture of about 70 weight % lauryl (C₁₂) and of about 30 weight % tetradecyl (C₁₄),
KCl: about 9 weight %
   Surfactant system 2: surfactant composition of matter comprising the following:
About 36% Active betaine: Alkyldimethylbetaine, wherein the alkyl is a mixture of about 70 weight % lauryl (C₁₂) and of about 30 weight % tetradecyl (C₁₄),
KCl: about 10 weight %
   Glyphosate compound: Glyphosate Acid tech. 95%-97% acid equivalent
   Glyphosate salt: Glyphosate isopropylamine salt solution, about 640 g/L acid equivalent (measured)
   Additive compounds:

KNO₃ used as a 30% aqueous solution

K₂HPO₄ used as a 50% aqueous solution

KH₂PO₄ used as a 30% aqueous solution

K Lactate used as a 60% aqueous solution

NMP: N-MethylPyrrolidone

NH₄NO₃ used as a 66% aqueous solution

In the examples, the letter “C” indicates a comparative example, “ai” stands for “active ingredient” and “ae” stands for “acid equivalent”.

### Example 1

### Preparation of Glyphosate Compositions

The glyphosate compositions below are prepared according to the following procedure:

### Procedure:

1) mixing the water of surfactant system 1. A slurry is obtained
2) add 50% of glyphosate compound and neutralize with a molar equivalent of isopropylamine, to obtain that comprise 50% of the final amount of the isopropylammonium salt
3) add the remaining 50% of glyphosate compound and neutralize with a molar equivalent of isopropylamine.
4) add the additive compound
The viscosity of the composition is measured at 25° C., with a RVT Brookfield Viscosimeter, Spindle No. 2, at 10 rpm.
Crystallization is evaluated after 1 week at room temperature (“RT”).

| | Glyphosate composition | | | | | | |
|---|---|---|---|---|---|---|---|
| | 1.1 C | 1.2 | 1.3 | 1.4 | 1.5 | 1.6 C | 1.7 C |
| Glyphosate | 540 g/L | 540 g/L | 540 g/L | 540 g/L | 540 g/L | 540 g/L | 540 g/L |
| (ae) | | | | | | | |
| Surfactant | 149 g/L | 149 g/L | 149 g/L | 149 g/L | 149 g/L | 149 g/L | 149 g/L |
| System 1 | | | | | | | |
| Additive | / | KNO₃ | K₂HPO₄ | KH₂PO₄ | K | NMP | NH₄NO₃ |
| compound | | | | | Lactate | | |
| Amount of | / | 5 wt % | 5 wt % | 5 wt % | 5 wt % | 5 wt % | 5 wt % |
| VRA as | | (1.5 wt %) | (2.5 wt %) | (1.5 wt %) | (3 wt %) | (5 wt %) | (3.3 wt %) |
| solution | | | | | | | |
| (amount as | | | | | | | |
| active) | | | | | | | |
| Water | To 1 L | To 1 L | To 1 L | To 1 L | To 1 L | To 1 L | To 1 L |
| Viscosity | 900 | 495 | 675 | 495 | 495 | 900 | 630 |
| (cps) | | | | | | | |
| Crystallization | No | No | No | No | No | No | Yes |
| RT | | | | | | | |

### Example 2

### Preparation of a Blend

68 wt % (as is) of the surfactant system 2 and 32 wt % of the K-Lactate solution are mixed together to obtain the blend below. The viscosity of the composition is measured at 25° C., with a RVT Brookfield Viscosimeter, Spindle No. 2, at 20 rpm.

| | |
|---|---|
| Bend | 2.1 |
| Additive | K Lactate |
| Amount of VRA - | 19.2% |
| wt % as active | |
| Amount of active | 24.5% |
| betaine | |
| Amount of KCl | 6.8% |
| Viscosity (cps) | 32-44 |

### Example 3

### Preparation of a Glyphosate Composition

The glyphosate composition below is prepared according to the following below, and tested.

| Glyphosate composition. | 3.1 |
|---|---|
| | (540 g/L glyphosate a.e.) |
| INGREDIENTS | g/L |
| Glyphosate salt - solution at 640 g/L a.e. | 1059.41 |
| Blend 2.1 | 163 |
| Water (Melbourne tap 30 ppm) | to 1 L (17.59 g) |
| Density (20° C.) g/cc | 1.240 ± 0.003 |
| Appearance | Clear colourless to slightly |
| | amber, semi-viscous liquid |
| pH (neat) | 4.9 |
| pH 7% w/w solution | 4.6 |

### Procedure:

Step 1) Preparation of the Glyphosate-Isopropylamine salt solution

| Glyphosate-Isopropylamine salt solution | |
|---|---|
| INGREDIENTS | g/L |
| Glyphosate Acid tech. 95.03% ai | 673.47 |
| Isopropylamine 100% ai | 223.72 |
| Water (Melbourne tap 30 ppm) | To Vol (358.41 g/L) |
| Density (20° C.) g/cc | 1.256 |
| Appearance | Clear colourless viscous liquid |
| pH neat | 4.9 |

1a) Gly-IPA solution is prepared in 2 steps. To 80% of the water, ½ of Glyphosate Acid powder tech. (95% min. purity) is added to form the slurry. The mixture is aminated gradually, with ½ of 100% Isopropylamine, which is pre-cooled to 0° C. The reaction temperature is maintained at approximately 55° C.
1b) The remaining ½ Glyphosate Acid technical is added and aminated with the remaining ½ of Isopropylamine. The pH of 7% w/w solution is checked to confirm value within 4.5-4.7
1c) Extra IPA, approx. 12%, is needed to fall within the required pH value. This is subtracted from the remaining 20% water and the remaining water added.
Step 2) Preparation of the composition (1 L in a 1.5 L bottle)
2a) Glyphosate-Isopropylamine salt solution is kept warm at 40° C. to prevent crystallization. For this purpose the preparation of the formulation is done by weight. Hence Gly-IPA conc. is weighed 1^{st} followed by Blend 3.1 and water.
2b) The mixture is mixed with a Lab propeller stirrer for 0.5 hours.
2c) Mixture is brought to 20° C. and its density value, pH neat and pH of 7% w/w solution determined.

### Tests and Results

### Chemical Stability (by Chromatography)

The amount of glyphosate (as acid equivalent) of composition 4.1 is measured at time zero, after 1 week at 0° C., and after 2 weeks at 54° C. The amount does not change (about 540 g/L ae)

### Low Temperature Stability (Method CIPAC MT 39.2)

Composition 4.1 is stable after 1 week at 0° C.

### Persistent Foam (Method CIPAC MT 47)

The test is performed at application rate of 0.8 L product/ha/100 L water=0.8 ml/100 ml

Melbourne tap water at ambient temperature (21.8° C.).

| | | Time (mins) | | | | |
|---|---|---|---|---|---|---|
| Sample | | zero | 5 | 15 | 30 | 60 |
| Composition 3.1 | Foam (ml) | 79 | 67 | 65.2 | 64 | 64 |
| Composition 3.1 after | Foam (ml) | 79 | 67 | 65.2 | 64 | 64 |
| 2 weeks at 54 C. | | | | | | |

The composition exhibits a particularly suitable low foaming.

### Solution Stability (Method CIPAC MT 41)

The test is performed at 5% v/v dilution, in Standard Water C at 20° C.

| Sample | Separation at 18 hours |
|---|---|
| Composition 3.1 | none |
| Composition 3.1 | none |
| after 2 weeks at | |
| 54° C. | |

### Physical Stability Accelerated (Method CIPAC MT 46) and Long Term

The tests are performed in HDPE and Glass bottles.

| Sample | Appearance/observations |
|---|---|
| Composition 3.1 - Time zero at RT | Clear colourless slightly-viscous |
| | liquid; pH neat 4.9 |
| Composition 3.1 - 1 week at 0° C. | Stable, no crystallization; |
| | pH neat 5.02 |
| Composition 3.1 - 2 weeks at 54° C. | Stable, no phase separation |
| | or discolouration; pH neat 5.03 |
| Composition 3.1 - 4 weeks at: | |
| RT | Stable, pH neat 5.0 |
| 30° C. | Stable, pH neat 5.0 |
| 40° C. | Stable, pH neat 5.0 |
| Composition 3.1 - 8 weeks at: | |
| RT | Stable; pH neat 5.05 |
| 30° C. | Stable; pH neat 5.05 |
| 40° C. | Stable; pH neat 5.05 |
| Composition 3.1 - 12 weeks at: | |
| RT | Stable; pH neat 5.05 |
| 30° C. | Stable; pH neat 5.05 |

### Compatibility

Composition 3.1 is diluted with water in a tank to a typical application concentration, and various further active products are added, to a typical application concentration. Composition 3.1 shows tank mix compatibility with 89% of the further actives. For example composition 3.1 shows compatibility with 2,4-D amine Soluble Liquid formulations, and with Atrazine Suspension Concentrate formulations.

1-25. (canceled)

26. A herbicidal aqueous composition comprising:
an aminophosphate or aminophosphonate salt;
a surfactant system comprising a surfactant product; and
an additive compound comprising:
salts comprising a cation and an anion,
wherein:
the cation is not Na⁺ and NH₄⁺, and
the anion comprises at least one oxygen atom and is not an anion of a dicarboxylic acid, an aminophosphate, and an aminophosphonate; and
an acid corresponding to the anion, provided that the composition also comprises a basic compound that is substantially free of Na⁺ or NH₄⁺.

27. The composition of claim 26 wherein the cation is K⁺.

28. The composition of claim 26, wherein the anion comprises:
an anion of a mono-carboxylic acid,
a sulfate or sulfonate,
a phosphate or phosphonate, or
a nitrate.

29. The composition of claim 26, wherein the salt comprising a cation and an anion comprises potassium lactate, KNO₃, KH₂PO₄, or K₂HPO₄.

30. The composition of claim 26, wherein the amount of the additive compound ranges from 5 g/L to 100 g/L.

31. The composition of claim 26, wherein said composition comprises at least 360 g/L of aminophosphate or aminophosphonate salt.

32. The composition of claim 26, wherein the aminophosphate or aminophosphonate salt comprises at least 10% by weight of isopropyl ammonium aminophosphate or aminophosphonate salt, or at least 10% by weight of potassium aminophosphate or aminophosphonate salt.

33. The composition of claim 26, wherein the surfactant product comprises:
an alkyl betaine having formula R¹R²R²N⁺—CH₂COO⁻,
an alkylamidobetaine having formula R¹—CONR³—R⁴—N⁺(R²)₂—CH₂COO⁻,
an alkyl amine oxide having formula R¹—N⁺(R²)₂—O⁻,
an alkylamidoamine oxide having formula R¹—CONR³—R⁴— N⁺(R²)₂—O⁻, or
mixtures thereof,
wherein:
R¹ is a linear or branched hydrocarbon group,
R², which is identical or different, comprises a C₁-C₃ alkyl group,
R³ is a hydrogen atom or a C₁-C₃ alkyl group, and
R⁴ is a divalent C₁-C₆ alkyl group.

34. The composition of claim 26, wherein the composition comprises at least 80 g/L of the surfactant system.

35. The composition of claim 26, wherein the surfactant system comprises:
a betaine surfactant composition of matter comprising:
water,
a betaine of formula R¹R²R²N⁺—CH₂COO⁻,
wherein:
R¹ is a linear or branched hydrocarbon group,
R², which is identical or different, is a C₁-C₃ alkyl group, and
at least 1% by weight of a chloride-based salt;
and/or
an amine oxide surfactant composition of matter comprising:
water,
an amine oxide having formula R¹—N⁺(R²)₂—O⁻,
wherein:
R¹ is a linear or branched hydrocarbon group,
R², which is identical or different, is a C₁-C₃ alkyl group, and
optionally a solvent not water;
further wherein said surfactant system optionally comprises at least one surfactant not the betaine of the betaine surfactant composition of matter and not the amine oxide of the amine oxide composition of matter.

36. The composition of claim 26, wherein the surfactant system comprises a surfactant active matter in an amount of at least 20% by weight.

37. The composition of claim 26, wherein the total surfactant active matter of the surfactant system in the composition comprises at least 20% by weight of betaine active matter or amine oxide active matter.

38. The composition of claim 35, wherein said composition comprises at least 80 g/L of a betaine and/or amine oxide surfactant composition of matter.

39. The composition of claim 35 wherein the betaine surfactant composition of matter comprises:
at least 20% by weight as active surfactant matter of the betaine, and
at least 2% by weight of a potassium chloride salt.

40. The composition of claim 26, comprising:
from 360 g/L to 560 g/L of the aminophosphate or aminophosphonate salt,
from 80 g/L to 180 g/L of the surfactant system, and
from 5 to 100 g/L of the additive compound.

41. A The composition of claim 26, comprising:
from 400 to 500 g/L of glyphosate isopropylamine salt,
from 80 to 140 g/L of the surfactant system, and
from 10 to 70 g/L of the additive compound.

42. The composition of claim 26, comprising:
from 500 to 525 g/L of glyphosate isopropylamine salt,
from 100 to 150 g/L of the surfactant system, and
from 10 to 70 g/L of the additive compound.

43. The composition of claim 26, comprising:
from 525 to 560 g/L of glyphosate isopropylamine salt,
from 120 to 180 g/L of the surfactant system, and
from 10 to 70 g/L of the additive compound.

44. The composition of claim 26, further comprising:
anti-foaming agents,
solvents, and/or
deposition control agents.

45. A process for preparing an herbicidal aqueous composition comprising:
an aminophosphate or aminophosphonate salt;
a surfactant system comprising a surfactant product; and
an additive compound comprising:
salts comprising a cation and an anion,
wherein:
the cation is not Na⁺ and NH₄⁺, and
the anion comprises at least one oxygen atom and is not an anion of a dicarboxylic acid, an aminophosphate, and an aminophosphonate; and
an acid corresponding to the anion, provided that the composition also comprises a basic compound that is substantially free of Na⁺ or NH₄⁺;
comprising the steps of:
a) preparing a blend comprising the surfactant product and the additive compound, and
b) mixing the blend with the further components of the composition.

46. The process of claim 45, wherein said aminophosphate or aminophosphonate salt comprises a glyphosate salt.

47. The process of claim 45, wherein step a) comprises preparing a betaine surfactant composition of matter by a process comprising the steps of:
1) reacting a compound of formula R¹R²R²N with chloroacetic acid to obtain a reaction product,
2) adding potassium hydroxide to increase the pH,
3) adding said additive compound, and
4) optionally, before or after step 3), adjusting the concentration or pH.

48. The process of claim 46, wherein step b) comprises the steps of:
mixing water and a whole or a part of the glyphosate salt,
adding a whole or a part of the blend, and
optionally mixing remaining parts of the glyphosate salt to the blend.

49. The process of claim 46, further comprising the steps of:
a′) mixing water and a whole or a part of the glyphosate salt, and then adding a whole or a part of the surfactant system;
b′) adding a whole or a part of the additive compound;
c′) optionally mixing remaining parts of the glyphosate salt with the surfactant system before or after step b′); and
d′) optionally mixing a remaining part of the additive compound, after step b′), or during or after step c′), if step c′) is performed after step b′).

50. A blend comprising:
water
from 17% to 28% by weight as active of:
an alkyl betaine of formula R¹R²R²N⁺—CH₂COO⁻,
an alkylamidobetaine of formula R¹—CONR³— R⁴—N⁺(R²)₂—CH₂COO⁻,
an alkyl amine oxide of formula R¹—N⁺(R²)₂—O⁻, or
an alkylamidoamine oxide of formula R¹—CONR³—R⁴—N⁺(R²)₂—O⁻,
wherein:
R¹ is a linear or branched hydrocarbon group,
R², which is identical or different, is a C₁-C₃ alkyl group,
R³ is a hydrogen atom or a C₁-C₃ alkyl group, and
R⁴ is a divalent C₁-C₆ alkyl group; and,
from 5% to 25% as active of an additive compound comprising:
salts comprising a cation and an anion,
wherein:
the cation is not Na⁺ and NH₄⁺,
the anion comprises at least one oxygen atom and is not an anion of a dicarboxylic acid, an aminophosphate and an aminophosphonate, and
an acid corresponding to the anion, provided that the composition also comprises a basic compound that is substantially free of Na⁺ or NH₄⁺.

51. The blend of claim 50, wherein the additive compound comprises potassium lactate, KNO₃, KH₂PO₄, or K₂HPO₄.

52. A process for preparing an herbicidal aqueous composition comprising:
mixing an aminophosphate or aminophosphonate salt with water;
adding a surfactant system comprising a surfactant product; and
adding an additive compound comprising:
salts comprising a cation and an anion,
wherein:
the cation is not Na⁺ and NH₄⁺, and
the anion comprises at least one oxygen atom and is not an anion of a dicarboxylic acid, an aminophosphate, and an aminophosphonate; and
an acid corresponding to the anion, provided that the composition also comprises a basic compound that is substantially free of Na⁺ or NH₄⁺.
